(19) United States
(12) Patent Application Publication
(10) Pub. No.: US 2021/0177139 A1
(43) Pub. Date: Jun. 17, 2021

(54) BRA RESCUE CLOSET

(71) Applicant: London Shonda Vaughan, Milwaukee, WI (US)

(72) Inventor: London Shonda Vaughan, Milwaukee, WI (US)

(21) Appl. No.: 17/025,714

(22) Filed: Sep. 18, 2020

Related U.S. Application Data
(60) Provisional application No. 62/948,022, filed on Dec. 13, 2019.

(51) Int. Cl. A47B 61/00; A47G 25/14; H04R 9/06

(52) U.S. Cl. CPC A47B 61/003; A47G 25/14; A47G 2025/1492; H04R 2420/07; H04R 9/06

(57) ABSTRACT

An article of manufacture for providing a specialized bra closet is disclosed. The article includes an enclosed cabinet having a plurality of columns of display hooks, a pair of enclosing doors coupled to an open side of the enclosed cabinet, a plurality of lights mounted on an inner top surface within the enclosed cabinet coupled to one or more contact switches about the pair of closing doors, the contact switches are configured to activate one or more of the plurality of lights when one of the pair of enclosing doors are opened, and a closing latch having components on both of the pair of enclosing doors and configured to engage the components of the other enclosing door when both of the pair of enclosing doors are in a closed position.

### RELATED APPLICATIONS

This application claims priority to U.S. Provisional Patent Application No. 62/948,022, titled “BRA RESCUE CLOSET,” and filed on Dec. 13, 2019. The entire application is incorporated herein by reference in its entirety

### TECHNICAL FIELD

This application relates in general to an article of manufacture for providing specialized personal storage, and more specifically, to an article of manufacture for providing a specialized bra closet.

### BACKGROUND

Individuals who wear woman's brassieres typically store them when not being worn in drawers, closets, and similar clothing storage locations. Many of these clothing storage locations do not take appropriate care of the bras while being stored. These clothing storage locations also do not provide an adequate display of clean bras when these individuals are preparing to dress for the evening.

Therefore, a need exists for an article of manufacture for providing a specialized bra closet according to the present invention. The present invention attempts to address the limitations and deficiencies of prior solutions according to the principals and example embodiments disclosed herein.

### SUMMARY

In accordance with the present invention, the above and other problems are solved by providing an article of manufacture for providing a specialized bra closet according to the principles and example embodiments disclosed herein.

In one embodiment, the present invention is an article of manufacture for providing a specialized bra closet. The article includes an enclosed cabinet having a plurality of columns of display hooks, a pair of enclosing doors coupled to an open side of the enclosed cabinet, a plurality of lights mounted on an inner top surface within the enclosed cabinet coupled to one or more contact switches about the pair of closing doors, the contact switches are configured to activate one or more of the plurality of lights when one of the pair of enclosing doors are opened, and a closing latch having components on both of the pair of enclosing doors and configured to engage the components of the other enclosing door when both of the pair of enclosing doors are in a closed position.

In another aspect of the present disclosure, the pair of enclosing doors each have a curved vertical edge, the pair of curved vertical edges being mirror images of the other enabling the pair of curved vertical edges to interlock when the pair of enclosing doors are in the closed position.

In another aspect of the present disclosure, each of the pair of enclosing doors are coupled to the enclosed cabinet by two or more hinges attached to the inner side of the pair of enclosing doors.

In another aspect of the present disclosure, the enclosed cabinet further comprises a Bluetooth speaker mounted onto an inner wall.

In another aspect of the present disclosure, the enclosed cabinet comprises 3 columns of display hooks, each of the hooks being spaced vertically within each column and being spaced to permit a woman's brassiere to hang vertically without contacting an adjacent display hook.

In another aspect of the present disclosure, each of the plurality of display hooks each have a pair of hanging hook members.

In another aspect of the present disclosure, the enclosed cabinet rests on a set of locking wheels located about each corner on an underside of the enclosed cabinet.

In another aspect of the present disclosure, the closing latch has a pair of attachment surfaces attached to each of the pair of closing doors, a protruding eyehook coupled to each of the pair of attachment surfaces, and a connecting hook having a first end coupled about a first protruding eyehook and a bent hook located about a second end, the connecting hook pivots about the first protruding eyehook to engage a second protruding eyehook with the connecting hook oriented across the curved edges of the pair of closing doors to hold the closing doors in the closed position.

In another aspect of the present disclosure, the enclosed cabinet further comprises an AC power cord coupled to an internal power supply for powering the plurality of lights.

In another aspect of the present disclosure, the Bluetooth speaker is powered by the internal power supply.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of an article of manufacture for providing a specialized bra closet according to the present invention.

FIG. 2 illustrates another example embodiment of an article of manufacture for providing a specialized bra closet with its doors closed according to the present invention.

FIGS. 3a-g illustrate an example embodiment of features and components within the specialized bra closet according to the present invention.

FIG. 4 illustrates an example embodiment of an electrical circuit used within a specialized bra closet according to the present invention.

### DETAILED DESCRIPTION

This application relates in general to an article of manufacture for providing specialized personal storage, and more specifically, to an article of manufacture for providing a specialized bra closet according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “woman,” and “user” refer to an entity, e.g. a human, using the specialized bra closet associated with the invention. The term user herein refers to one or more users.

The term “invention” or “present invention” refers to the invention being applied for via the patent application with the title “Bra Rescue Closet.” Invention may be used interchangeably with bra home and bra cabinet.

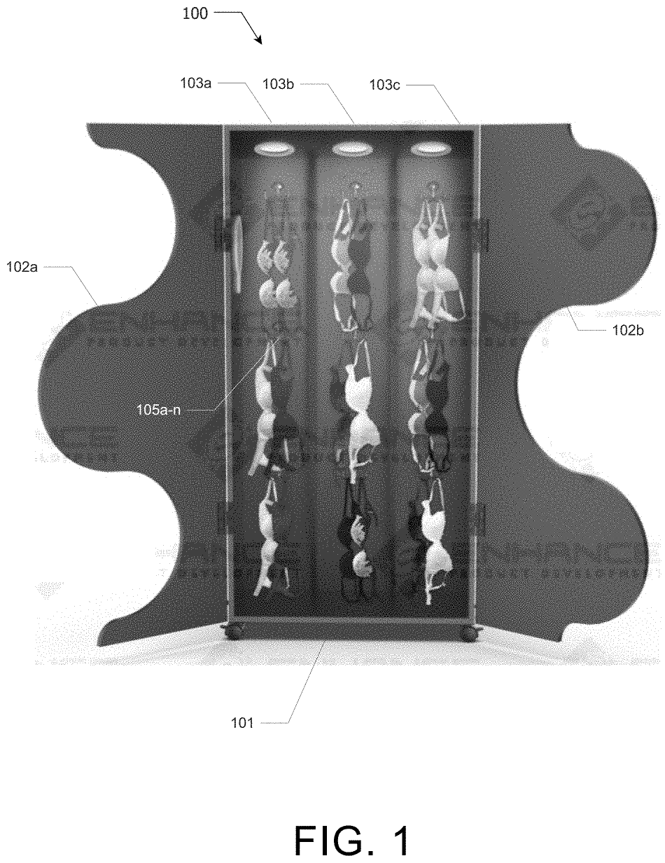

In general, the present disclosure relates to an article of manufacture for providing specialized personal storage. To better understand the present invention, FIG. 1 illustrates an example embodiment of an article of manufacture for providing a specialized bra closet. The specialized bra cabinet 100 comprises a large cabinet enclosure 101 with a pair of doors 102a-b on a front side. When the doors are open, the enclosure 101 has a set of columns 103a-c for storing one's bras. Each of the columns 103a-c has a set of hooks 105a-n that are spaced apart to permit a first bra hanging from a hook 105a-n not to touch another hook or the flooring surface that is directly below it.

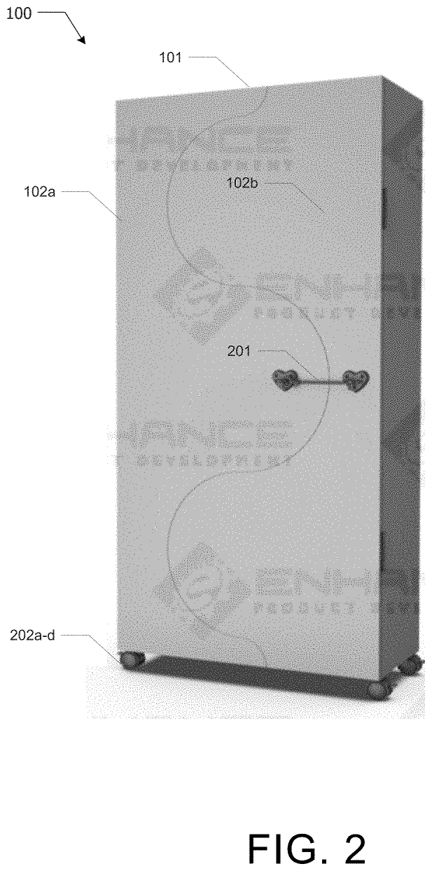

FIG. 2 illustrates another example embodiment of an article of manufacture for providing a specialized bra closet with its doors closed according to the present invention. FIG. 2 shows the specialized bra cabinet 100 having its doors 102a-b in a closed position. The enclosure 101 rests on a plurality of rolling wheels to permit the enclosure 101 to be easily moved around by a user. The doors 102a-b mate with each other such that the entire front of the enclosure 101 is covered when the pair of doors 102a-b are in this closed position. The doors 102a-b are attached to the enclosure using hinges 104a-d between the enclosure and outer edges of each of the doors 102a-b.

In this embodiment, the pair of doors 102a-b each has a decoratively-shaped curved edge that interlocks with a corresponding curved edge of the other door. A closing latch 201 connects components on each of the doors on the outside surfaces of the doors. The closing latch 201 is positioned such that the edges of the doors 102a-b, when closed, pass under a connecting part of the latch 201. The hinges 104a-d are arranged to be hidden between the enclosure 101 and the pair of doors 102a-b when closed.

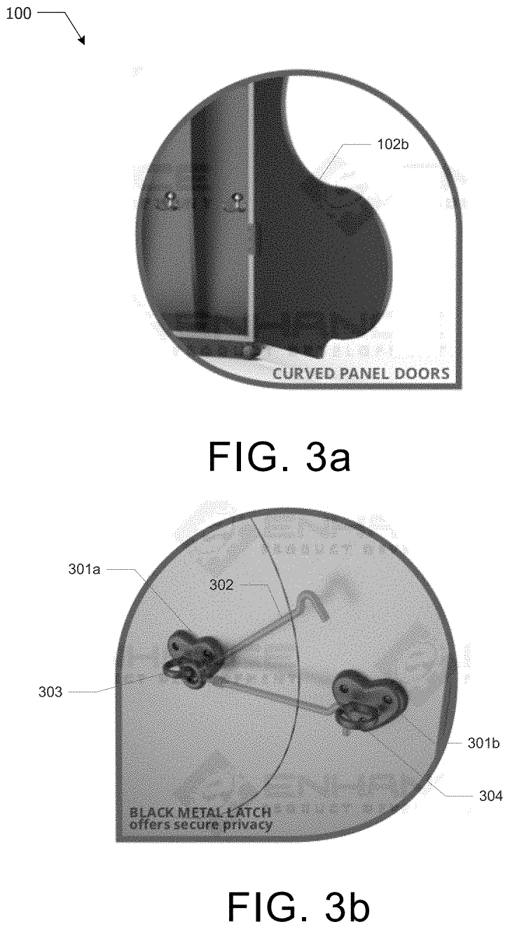

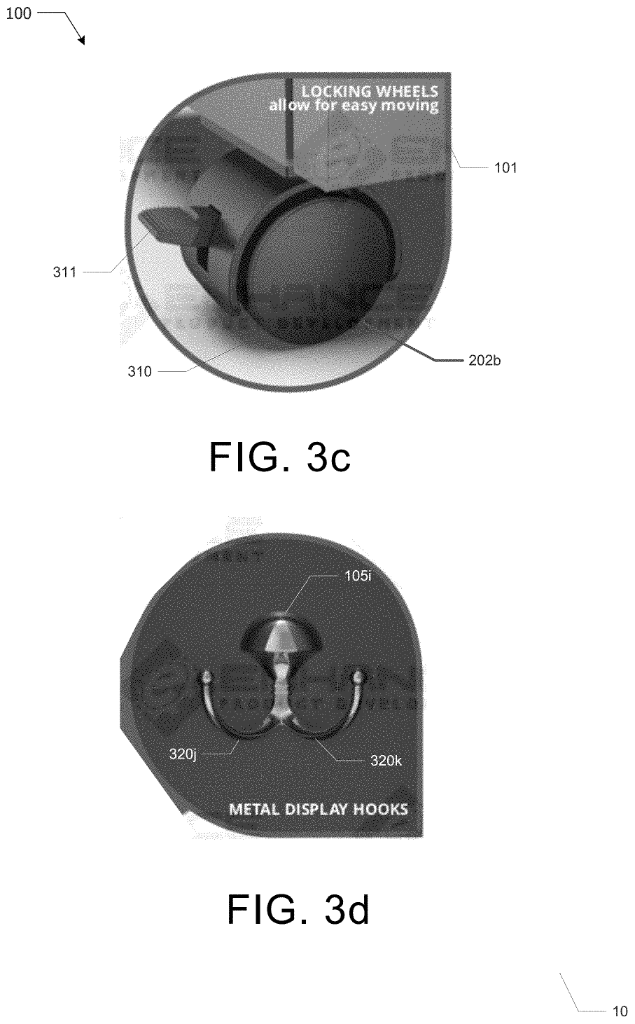

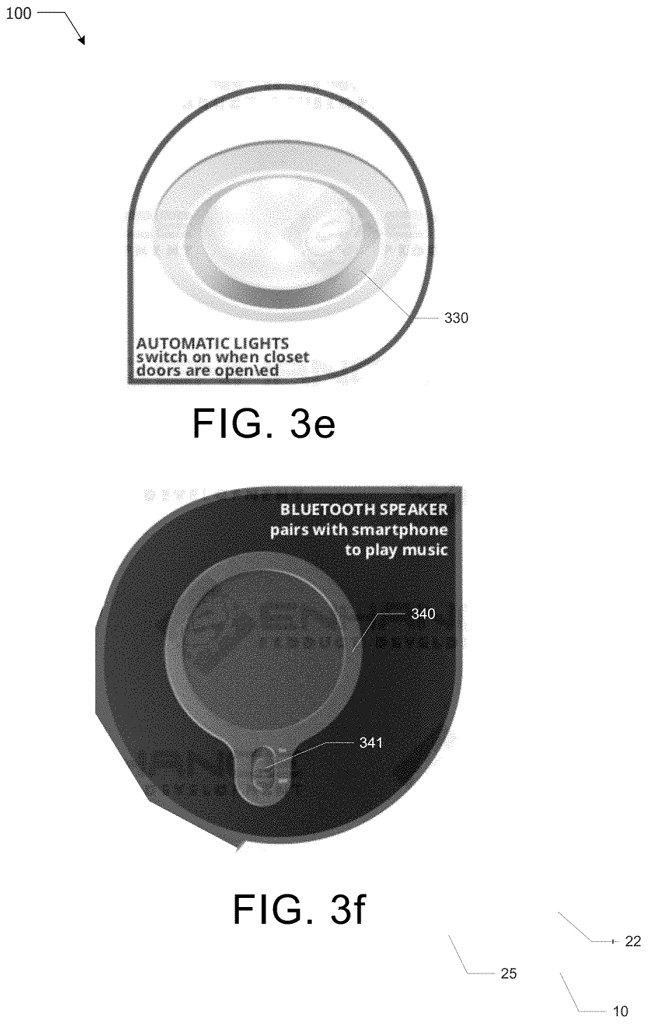

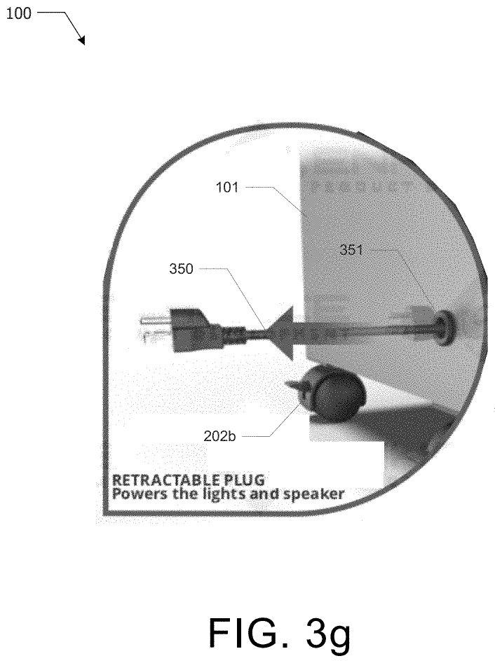

FIGS. 3a-g illustrate an example embodiment of features and components within the specialized bra closet according to the present invention. Each of the elements shown in FIGS. 3a-g are part of the specialized bra closet 101 as disclosed above in reference to FIGS. 1-2. FIG. 3a shows one of the doors 102b attached to the enclosure 101 by one or more hinges 104d. The mating, inner edge 300b of the door 102b is shown to have a curved pattern. A mirror image of the curved edge 300a from a first door 102a is created on the second curved edge 301b of the second door 102b permitting the two curved edges 300a-b to interlock with each other when closed.

FIG. 3b shows a closing latch 201 comprising a pair of attachment surfaces 301a-b, each having a protruding eyehook 303-304. The pair of attachment surfaces 301a-b are positioned such that the edges 300a-b of the doors 102a-b, when closed, pass under a connecting hook 302 between a pair of attachment surfaces 301a-b. The connecting hook 302 has one end connected to a first eyehook 303 using an attached ring encircling the eyehook 303. The connecting hook 302 has a bent hook in its latching member that engages the second eyehook 304 when the pair of doors 102a-b are in the closed position. The pair of attachment surfaces 301a-b are coupled to the pair of doors 102a-b using screws thru the attachment surfaces and into each door 102a-b.

FIG. 3c shows one of a plurality of locking wheels 202b that is shown attached to a corner of the enclosure on its lower outside surface. Each wheel 202a-d has a locking lever 310a-d that engages an inner wheel 311 to prevent it from rolling. A locking lever, such as the one in FIG. 3c, 310b locks its corresponding wheel 202b when depressed. When the locking lever 310b is moved to an upper position, the inner wheel 311b may rotate once again.

FIG. 3d shows one of a plurality of display hooks 105i that are positioned within the enclosure 101 and arranged into columns 105a-c. Each of plurality of display hooks 105a-n has one or more hanging hook members 320a-m to provide a large number of points in the enclosure 101 to hang up a user's bras. In the embodiment of FIG. 3d, the display hook 105i is shown having a pair of hanging hook members 320j-k. The display hook 105i is shown to be made of metal, such as brass or steel, although many other materials may be used. Each of the display hooks 105a-n are attached to the inner back surface of the enclosure using nails, screws, hooks, adhesives, Velcro™, and many other attachment mechanisms.

FIG. 3e shows one of a plurality of lights 330 that are placed onto an upper, inner surface of the enclosure 101 to provide illumination for a column of display hooks and bras in the enclosure 101. The light 303 is electrically powered and may use LED, fluorescent and incandescent light bulbs that are powered by a battery or a power source. The lights 303 in the enclosure 101 are controlled by a contact switch between the pair of doors 102a-b and the enclosure 101. When the doors 102a-b are opened the contact switch disengages its contact with the enclosure to trigger the activation of the lights 330. All of the lights may be controlled using a contact switch associated with one of the pair of doors 102a in one embodiment. In a second embodiment, a contact switch may be located between the enclosure 101 and each of the doors 102a-b and configured to control half of the lights 330 using one contact switch and control the remaining lights with the second contact switch.

FIG. 3f shows a Bluetooth connected speaker 340 having a power switch 341 located as part of the speaker 340. The speaker 340 may be mounted on an inner surface of the enclosure 101 and in a preferred embodiment, the speaker 340 is located on an inner side wall surface. Electronics for establishing a Bluetooth connection with an external audio source receiving an audio data stream, and for generating sound corresponding to the audio data stream, may be integrated into the inner housing of the speaker 340. The speaker may be powered by an internal battery or from a power connection to an internal power source for all of the electronics in the specialized bra closet 100.

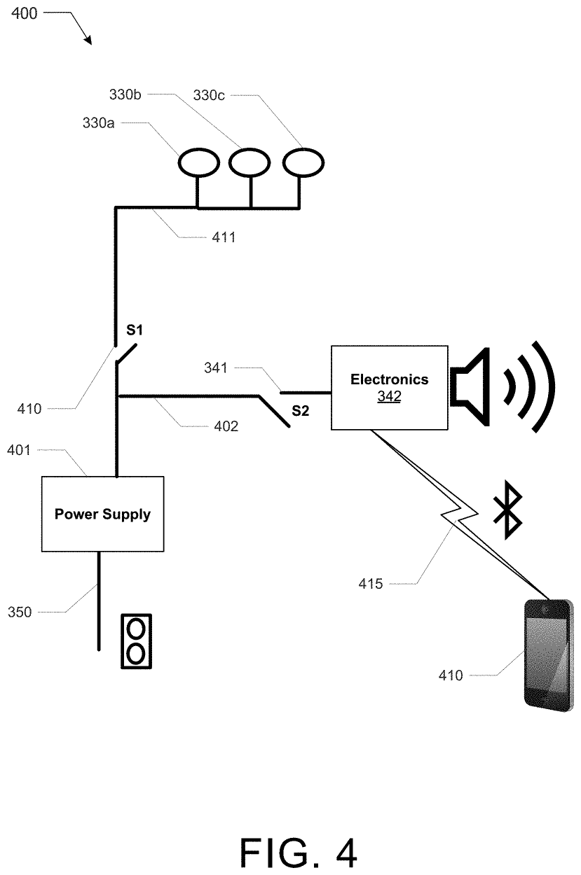

FIG. 3g shows a retractable AC power cord 350 exiting a connection port 351 in the enclosure 101. The retractable power cord 350 may automatically retract using a spring-powered spool within the enclosure 101 in which the power cord 350 is electrically connected to a power supply that is also in the enclosure. The power supply as disclosed below in reference to FIG. 4 may generate power sources of appropriate voltage to power the lights 330 and Bluetooth speaker 340.

FIG. 4 illustrates an example embodiment of an electrical circuit used within a specialized bra closet according to the present invention. The circuit 400 shows the electrical connections between the components in the enclosure 101. The retractable power source 350 supplies AC/voltage from a wall outlet to a power supply 401. The power supply 401 generates one or more voltages 402 that provide operating electrical power to one or more of the lights 330a-c and the Bluetooth speaker 340.

In the example embodiment of FIG. 4, both the Bluetooth speaker 340 and the lights 330a-c are powered by the same supply voltage 402. Of course, the power supply 410 may generate a separate supply voltage of an appropriate value for each of these devices when different voltages are needed. The supply voltage 402 is connected to a first switch 410 that when closed provides a first switched supply voltage to the lights 330a-c. The first switch 410 corresponds to the contact switch disclosed above with reference to the opening and closing of the doors 102a-b to activate the lights 330a-c.

The supply voltage 402 also is connected to the input of the activation switch 341 that is part of the Bluetooth speaker 340. This switch 341 disclosed in reference to FIG. 3f, is an integral part of the Bluetooth speaker 340. When the user closes this switch 341, the supply power is provided to the electronics 342 that operates the speaker 340. The electronics 342 use the Bluetooth™ protocol to establish a connection 415 to an external device 420. A smartphone 420 is shown in FIG. 4 as an example of a device that may act as an external device 520 that provides an audio data stream to the speaker 340.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a specialized bra closet, the article comprises:
an enclosed cabinet having a plurality of columns of display hooks;
a pair of enclosing doors coupled to an open side of the enclosed cabinet;
a plurality of lights mounted on an inner top surface within the enclosed cabinet coupled to one or more contact switches about the pair of closing doors, the contact switches are configured to activate one or more of the plurality of lights when one of the pair of enclosing doors are opened; and
a closing latch having components on both of the pair of enclosing doors and configured to engage the components of the other enclosing door when both of the pair of enclosing doors are in a closed position.

2. The article of manufacture according to claim 1, wherein the pair of enclosing doors each have a curved vertical edge, the pair of curved vertical edges being mirror images of the other enabling the pair of curved vertical edges to interlock when the pair of enclosing doors are in the closed position.

3. The article of manufacture according to claim 2, wherein each of the pair of enclosing doors are coupled to the enclosed cabinet by two or more hinges attached to the inner side of the pair of enclosing doors.

4. The article of manufacture according to claim 1, wherein the enclosed cabinet further comprises a Bluetooth speaker mounted onto an inner wall.

5. The article of manufacture according to claim 1, wherein the enclosed cabinet comprises 3 columns of display hooks, each of the hooks being spaced vertically within each column and being spaced to permit a woman's brassiere to hang vertically without contacting an adjacent display hook.

6. The article of manufacture according to claim 5, wherein each of the plurality of display hooks each have a pair of hanging hook members.

7. The article of manufacture according to claim 1, wherein the enclosed cabinet rests on a set of locking wheels located about each corner on an underside of the enclosed cabinet.

8. The article of manufacture according to claim 2, wherein the closing latch comprising:
a pair of attachment surfaces attached to each of the pair of closing doors;
a protruding eyehook coupled to each of the pair of attachment surfaces; and
a connecting hook having a first end coupled about a first protruding eyehook and a bent hook located about a second end, the connecting hook pivots about the first protruding eyehook to engage a second protruding eyehook with the connecting hook oriented across the curved edges of the pair of closing doors to hold the closing doors in the closed position.

9. The article of manufacture according to claim 4, wherein the enclosed cabinet further comprises an AC power cord coupled to an internal power supply for powering the plurality of lights.

10. The article of manufacture according to claim 9, wherein the Bluetooth speaker is powered by the internal power supply.
